(19) United States
(12) Patent Application Publication
(10) Pub. No.: US 2011/0011843 A1
(43) Pub. Date: Jan. 20, 2011

(54) ADAPTER FOR A WELDING DEVICE

(76) Inventor: Ralph Meichtry, Richterswil (CH)

Correspondence Address: OSTROLENK FABER GERB & SOFFEN, 1180 AVENUE OF THE AMERICAS, NEW YORK, NY, 100368403, US

(21) Appl. No.: 12/504,275

(22) Filed: Jul. 16, 2009

(51) Int. Cl. B23K 9/00

(52) U.S. Cl. 219/136

(57) ABSTRACT

An adapter for a welding device for temporary fastening of a welding eye onto a surface is provided. The adapter comprises an electrically conducting inner part acting as a first electrode and an electrically conducting outer part acting as a second electrode in connection with the welding eye. Between the inner and the outer part a spacer made of an insulating material is arranged. The inner part protrudes above the outer part to form a contact element between the welding device and the surface. At least one holding means is arranged at the outer part, which is suitable to temporarily hold at least one welding eye such that a welding current can be applied between the inner part and the welding eye via the surface to weld the welding eye to the surface.

### BACKGROUND

1. Field of the Disclosure

The present disclosure relates to an adapter for a welding device for temporary fastening a welding eye onto a surface, according to the preamble of the independent claim.

2. Related Art

From the state of the art several methods and devices are known to remove dents out of metal sheets. In principle all techniques have in common, that a pulling force is applied on a load initiating element, which is connected irremovably with the damaged metal surface. A method for the connection of a load initiating element is for example stud welding. Stud welding or spot welding has applications in many industries, such as car manufacturing or ship building. It is an easy and efficient method to fix a fastener device on a metal sheet. Depending on the geometry of the stud, different stud holders are necessary, which provide a suitable connection between the welding device, the stud and the grounding connection of the stud.

The DE 20 2005 014 256 U1 for example provides a stud welding device for ring-like welding elements. In order to position the welding element precisely, a centering pin is necessary. The described stud welding device with the stud holder are together used to provide a permanent welding connection between the welding element and the metal surface.

Another holder for a hand held welding device is proposed in US 2008/0110867. The herein described device is designed for holding pin-like studs. Furthermore a special retention device for the stud is provided.

A third type of stud holder is described in DE 19514670. The proposed holder is mainly used for studs with a head and a cylinder-like neck. The described stud holder comprises a cylinder like hollow part with a resilient opening. When the stud is inserted into the stud holder, the resilient part of the holder fixes the stud.

The cited documents propose holders for screw-like, cylinder like or pin-like studs.

### SUMMARY

An object of the invention is to provide an adapter for a welding device, which improves fastening and positioning of a welding eye, on a damaged metal sheet. These and other objects are achieved by an adapter according to the independent claim. Preferred embodiments of the present invention are given in the dependent claims.

The invention is relates to an adapter for a welding device, in particular for holding at least one welding eye, wherein said welding eye comprises a ring member and an arm member, manufactured in one piece.

The used welding device is preferably a hand held welding device, like a stud welding gun. For the attachment of an adapter according to the invention the welding gun provides a head, which comprises at least two concentrically arranged cylinder elements. The adapter according to the invention is attached to the head of the welding gun and when the trigger is pressed, a welding current is applied between the welding gun and the damaged metal sheet through the welding eye.

The adapter according to the present application comprises an electrically conducting outer part, for example a metal ring or a rectangular metal block with an opening substantially in the middle part of said block or said ring. The opening is for example shaped cylindrically and an electrically conducting inner part can be arranged movable with respect to the outer part in said opening. Further, a spacer is provided between the inner and the outer part, e.g. an isolating ring.

In one embodiment of the present application the inner part is e.g. stud made of copper. The stud serves as a contact element between the welding device and the damaged metal surface. The inner part is acting as a first electrode and the electrically conducting outer part is acting as a second electrode in connection with the welding eye.

The holding means, is a clamping element comprising for example a plate which is arranged peripheral at the rectangular metal block. When the outer part is formed as a ring the holding means is arranged tangential to said ring. The connection between the plate of the holding means and the outer part is for example a spring-loaded connection.

Before starting the welding process the adapter is attached to the welding device. The welding eye, in particular the ring member of the welding eye, is clamped between the plate of the holding means and the outer part. In this position the arm member of the welding eye is substantially parallel to the inner part. This arrangement relates to a distance between the arm member and the inner part. The outer part together with the holding mean and the welding eye are acting as a second electrode.

When the welding process is started the inner part (copper stud) and the arm member are pressed against the damaged metal surface. The inner part may be movable in axial direction with respect to the outer part to improve the adaptability to the uneven surface.

When a welding current is applied between the inner part and the welding eye via the metal surface the tip area of the arm member is melted and the welding eye is temporary fastening to the damaged metal surface. The welding connection is punctual between the arm member and the surface. After pulling out the dent the welding eye is removed and the repaired sheet is polished.

In order to distribute the pulling force constantly into the dent a certain number of welding eyes have to be fastened on the damaged metal sheet, preferably very close to each other. This is possible with the configuration according to the present invention, because the holding means for clamping the pulling electrode is arranged in the periphery of the outer part, e.g. tangential to the ring element or on one outer surface of the rectangular metal block. Second, the welding eye, consisting of the ring member and the arm member, has a flat geometry. Third, the welding eye is located in a certain distance from the inner part. This configuration is advantageous. The welding eyes can be welded very close to each other and the applied load is distributed smoothly into the damaged metal sheet, which is decisive for an effective dent removal.

According to the present application an adapter for the attachment on a welding device, for temporary fastening of a welding eye onto a surface, comprising an electrically conducting inner part acting as a first electrode and an electrically conducting outer part acting as a second electrode is proposed. Between the inner and the outer part a spacer is arranged, which is made out of an insulating material. The inner part protrudes above the outer part to form a contact element between the welding device and the surface. At least one holding means is arranged at the outer part and is suitable to temporarily hold at least one welding eye such that a welding current can be applied between the inner part and the welding eye via the surface to weld the welding eye to the surface. The inner part is arranged movably, such that the inner part can be adjusted with respect to the outer part. The inner part is for example movable in axial direction with respect to the outer part. The outer part comprises fastening means to attach the welding adapter to the welding device. In a second embodiment the outer part has an annular shape and the inner part is arranged concentric to the outer part.

The holding means comprises a clamping element, which is spring-loaded and clamps the welding eye. In one embodiment of the invention the clamping element is clamped by a fastening screw. The holding means may be arranged at the periphery of the outer part such that several welding eyes can be welded close to each other to the surface.

Furthermore, a kit comprising a welding adapter according to one of the preceding described embodiments of the present invention and a welding eye is proposed.

### BRIEF DESCRIPTION OF THE DRAWINGS

In order to facilitate a better understanding of the present invention, reference is now made to the appended drawings. These references should not be construed as limiting the present invention.

FIG. 1 shows the welding adapter according to the invention in a first side view, with the inner part acting as a first electrode, the outer part with the holding mean and the clamped welding eye.

FIG. 2 shows the welding adapter according to the invention in a second side view, illustrating the holding mean for clamping the welding eye in more detail.

FIG. 3 shows the welding adapter from FIG. 1 and FIG. 2 in a perspective view from above.

FIG. 4 is a sectional view of FIG. 2, showing the main parts of the welding adapter according to the invention, comprising the inner part, the outer part, the fastening means, the holding means for clamping the welding eye and the spacer.

FIG. 5 is a first side view of a second embodiment of the welding adapter according to the invention, where the holding mean for clamping the welding eye is fixed on the outer part by using a spring-loaded connection.

FIG. 6 is a second side view of FIG. 5, showing the clamped welding eye, the holding mean, the outer part and the inner part.

FIG. 7 shows a perspective view from above of the welding adapter according to FIG. 5 and FIG. 6. This Figure illustrates the spring, fixing the holding means tangential on the outer part.

FIG. 8 shows a sectional view of FIG. 6, representing the outer part, the inner part, the spacer, the holding mean, the clamped welding eye and the spring.

FIG. 9 shows the hand held welding device with the mounted welding adapter from FIG. 5 to FIG. 8, in a perspective view from above.

FIG. 10 shows the hand held welding device with the mounted welding adapter in a side view.

FIG. 11 shows the welding eye used in the welding adapter according to the invention comprising an arm member to be welded on the damaged metal sheet and a ring member.

### DETAILED DESCRIPTION OF THE EMBODIMENTS

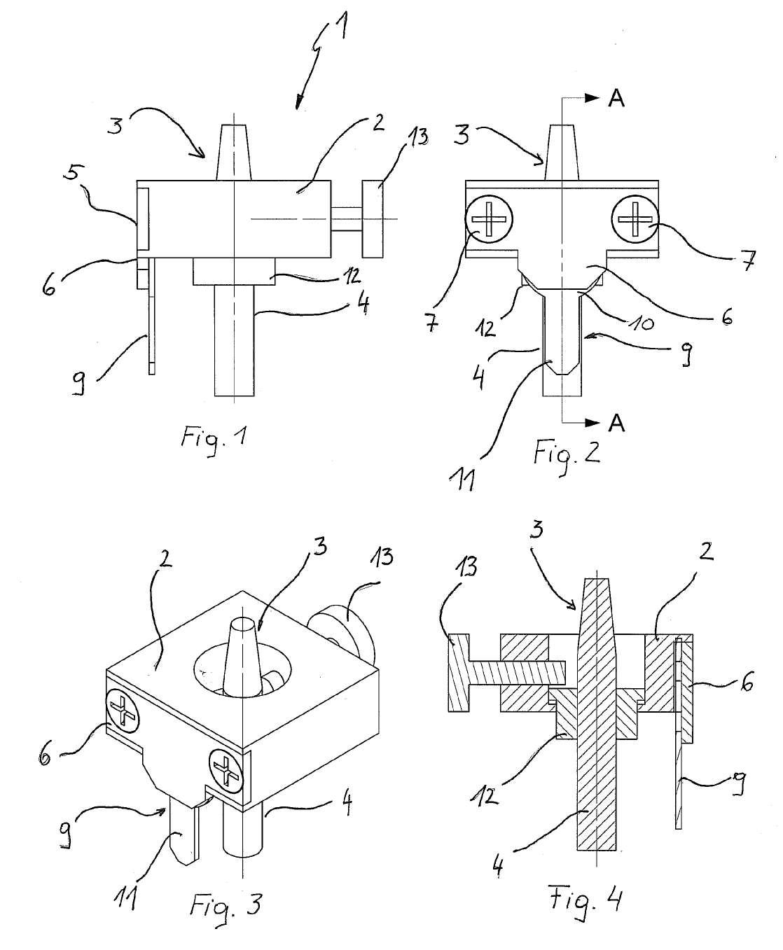

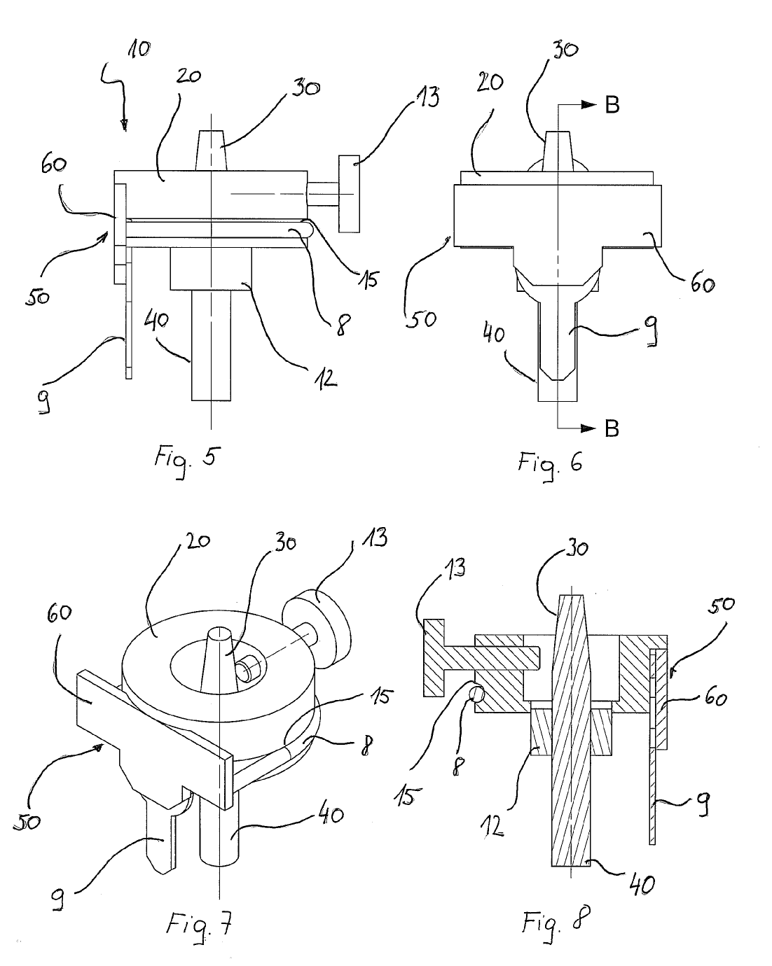

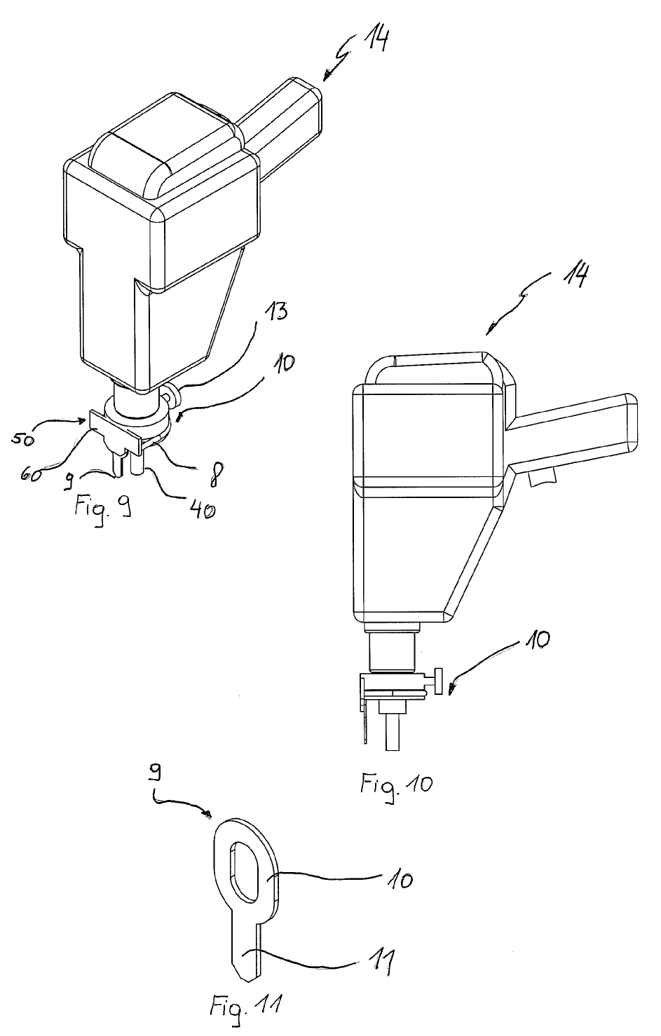

One embodiment of the welding adapter 1 according to the invention is shown in FIG. 1, comprising an outer part 2, an inner part 3, a holding mean 5, a clamped welding eye 9, a spacer 12 and a fastening means 13. In one embodiment of the invention the outer part 2 is formed as a rectangular block made of an electrically conducting metal such as copper.

The rectangular block has for example an edge length of approximately 4 to 10 cm and a thickness of 0.5 to 3 cm. The outer part 2 together with the welding eye 9 represent the first electrode. The inner part 3 represents the second electrode.

In the middle part of the outer part 2 an opening for mounting the inner part 3 is provided. The inner part 3 protrudes above the outer part 2 on two of the six surfaces of the rectangular block. The inner part 3 forms a contact element 4, which is attached to the welding device 14 and which contacts the welding device with the metal surface (not shown). The contact element 4 has a cylinder-like ending and a conical ending.

The spacer 12 is located between the outer part 2 and the inner part 3. The spacer is for example a ring, made of an isolating material.

When the welding adapter 1 is a attached to the welding device 14 the inner part 3 is movable in axial direction with respect to the outer part 2.

On one of the four side surfaces of the outer part 2 the fixation of the holding means 5 is provided. As illustrated in FIG. 2, the holding means 5 comprises a plate 6, fixed to the side surfaces of rectangular metal block by using fastening screws 7.

In one embodiment, the connection between the holding means 5 and the side surface of the rectangular metal block is spring-loaded. The welding eye 9, in particular the ring member 10, is clamped between the plate 6 and one of the side surfaces of the outer part 2. The clamped welding eye 9, in particular the arm member 11 is arranged parallel to the inner part of the welding adapter 1. Furthermore a fastening means 13 to fasten the adapter 1 on the welding device 14 is provided. In one embodiment of the invention the fastening means is a screw or a bolt, which penetrates the outer part 2 on one of the four side surfaces, when the outer part 2 is formed as a rectangular metal block.

A second embodiment of the adapter 10 is shown in FIG. 5 to FIG. 8. The outer part 20 has an annular shape, e.g. the outer part is formed as a cylinder with an opening in the axial direction to the cylinder. The outer part 20 has for example an outer diameter of 5 to 10 cm, an inner diameter of 1 to 4 cm and a thickness of 1 to 5 cm. The cylinder is for example made of a light metal, such as an aluminium alloy. The inner part 30 is arranged in the opening of the cylinder-like outer part 20 and protrudes above the outer part 20 on both sides of the opening of the cylinder 20. The inner part 30 forms a contact element 40, which is attached to the welding device 14 and which contacts the welding device 14 with the metal surface (not shown). The inner part 30 is made of an electrically conducting material, such as copper. It can for example be formed as a stud. One ending of the stud has a cylinder-like form, the opposite ending, which is attached to the welding adapter, has a conical form.

Between the inner part 30 and the outer part 20 a spacer 12 is provided. The spacer 12 is made of an isolating material such as a polymer material or a ceramic material. Both the inner part 30 and the outer part 20 are made of an electrically conducting material and represent a first and a second electrode.

In the second embodiment of the present invention a clearance 15 circulates the outer surface of the cylinder 20. The clearance 15 provides a guiding member for a fixing means 16. In the second embodiment of the invention the fixing means 16 is a spring 8.

The holding means 50 for the welding eye 9 comprises a plate 60. The plate 60 is arranged tangential to the outer surface of the cylinder 20 and is fixed by the spring 8. The plate 60 and the spring 8 represent a clamping element. The welding eye 9, in particular the ring member 10 is clamped between the holding means 50 and the cylinder 20. The spring 8 can be replaced by another elastic element, for example by a metal band. As in the first embodiment a fastening means 13 protrudes the outer surface of the cylinder 20. The fastening means 13 is for example a screw, which penetrates the cylinder and attaches the outer part 20 to the welding device 14.

FIG. 9 and FIG. 10 show the welding adapter 10 attached to a welding device 14. The inner part 30 is connected with the head of the welding device 14 and is fixed with the fastening means 13. As shown in FIG. 9 the arm member 11 of the welding eye is arranged parallel to the inner part 20 of the welding adapter 10.

FIG. 11 shows one possible embodiment of a single welding eye 9. In this embodiment the welding eye 9 is manufactured from one piece comprising a ring member 10 and an arm member 11. The welding eye 9 is for example made of steel panel with a thickness of e.g. 1 to 4 mm.

Although the present invention has been described in relation to particular embodiments thereof, many other variations and modifications and other uses will become apparent to those skilled in the art.

### LIST OF REFERENCE NUMERALS

1, 10 adapter
2, 20 outer part, cylinder
3, 30 inner part
4, 40 contact element
5, 50 holding means
6, 60 plate
7 fastening screw
8 spring
9 welding eye
10 ring member
11 arm member
12 spacer
13 fastening means
14 welding device
15 clearance
16 fixing means

What is claimed is:

1. An adapter for a welding device for temporary fastening of a welding eye onto a surface, comprising
a. an electrically conducting inner part acting as a first electrode and
b. an electrically conducting outer part acting as a second electrode in connection with the welding eye, and
c. a spacer arranged between the inner and the outer part and made out of an insulating material; whereby
d. the inner part protrudes above the outer part to form a contact element between the welding device and the surface, and
e. at least one holding means arranged at the outer part and suitable to temporarily hold at least one welding eye such that a welding current can be applied between the inner part and the welding eye via the surface to weld the welding eye to the surface.

2. The adapter of claim 1, wherein the inner part is arranged movably with respect to the outer part such that the inner part can be adjusted with respect to the outer part.

3. The adapter of claim 1, wherein the outer part comprises fastening means to attach the welding adapter to the welding device.

4. The adapter of claim 1, wherein the outer part has an annular shape.

5. The adapter of claim 1, wherein the inner part is arranged concentric to the outer part.

6. The adapter of claim 1, wherein the holding means comprises a clamping element to clamp the welding eye.

7. The adapter of claim 6, wherein the clamping element is spring-loaded.

8. The adapter of claim 6, wherein the clamping element is clamped by a fastening screw.

9. The adapter of claim 1, wherein the holding means is arranged at the periphery of the outer part such that several welding eyes can be welded close to each other to the surface.

10. Kit comprising a welding adapter according to claim 1 and a welding eye.
